(19) United States
(12) Patent Application Publication
(10) Pub. No.: US 2014/0063662 A1
(43) Pub. Date: Mar. 6, 2014

(54) Solar panel, power inverter, theft and arc protection system and methods of protection

(71) Applicant: Kenneth Scott, Sunnyvale, CA (US)

(72) Inventor: Kenneth Scott, Sunnyvale, CA (US)

(73) Assignee: Eco Power Design LLC, Sunnyvale, CA (US)

(21) Appl. No.: 13/987,676

(22) Filed: Aug. 21, 2013

Related U.S. Application Data
(60) Provisional application No. 61/743,109, filed on Aug. 27, 2012.

(51) Int. Cl. G08B 13/22; H02H 3/16

(52) U.S. Cl. CPC G08B 13/22; H02H 3/16
USPC 361/42; 307/149

(57) ABSTRACT

The present invention provides a system and method for individual or plural detection of the presence or absence of at least one installed solar panels whether or not the individual solar panel or the plurality of solar panel(s) operates to produce power during the detection process and whether or not the detection is conducted during the day or night, wherein the presence or absence of an individual solar panel or of a plurality of solar panels producing power during detecting comprises detecting presence or absence of one or more solar panels by an associated system that measures power output, and wherein during the detecting process insufficient voltage is produced for the associated system to measure power output. In addition, the present invention provides a means to detect a fire or arcing that may damage a power system, and can provide notification of the need for servicing the power system.

### BACKGROUND OF THE INVENTION

Solar panels and inverters can cost 10's of thousands of dollars even for a single residence. These panels and inverts can usually be removed from a roof or pole with very simple tools and sold on the internet where thieves can realize considerable profit. For this reason theft of solar systems is becoming more and more common. This trend will only increase once solar systems become more popular and the knowledge of how easy panel and inverter theft can be and how profitable their black market resale can be. Moreover, in addition to losses caused by theft, these expensive systems can be easily damaged by arc faults that can potentially cause fires or damage other electrical components of these systems.

Prior conventional anti-theft protection means typically consist of:
Special hardware is used to make it difficult to remove the fastenings that are holding the solar panel in place.
Many panels are fastened together to make it more difficult to transport the resulting larger solar panel array.
Designing panels distinctively to make it easier to identify the solar panels as stolen property.

While all of the above anti-theft methods can help to protect the system against theft, improved methods with additional protection are needed to scare away potential burglars or thieves or that will give a silent warning to authorities to provided enhanced protection of the solar panels and system.

Further solar panels produce DC current and that current or current associated with the AC grid wiring system can provide electrical arcs that can cause fires and/or damage the solar power system. More particularly, if there are any loose connections or damaged insulation in the DC circuit portions of the solar power systems, DC circuit arcing can occur that can cause fires. Also, the AC grid wiring of the power systems after inversion of the electricity to AC power can also produce arc faults.

There is a need to address arcing faults to reduce damage caused by one or more of: (a) adding a combined arc and over current breaker feeding power inverter(s) of the system, or (b) adding conventional arc detection circuitry into the inverter circuitry to make the inverter a multipurpose device.

Accordingly, there are also needed improved or additional systems and methods to protect solar panel systems against thievery or damage to the system that may be caused by attempted theft, or damage caused by one more types of arcing.

### BRIEF SUMMARY OF THE INVENTION

In one embodiment, the present invention provides a system and method for individual or plural detection of the presence or absence of at least one installed solar panels whether or not the individual solar panel or the plurality of solar panel(s) operates to produce power during the detection process and whether or not the detection is conducted during the day or night, wherein the presence or absence of an individual solar panel or of a plurality of solar panels producing power during detecting comprises detecting presence or absence of one or more solar panels by an associated system that measures power output, and wherein during the detecting process insufficient voltage is produced for the associated system to measure power output, the detection of presence or absence of one or more solar panels comprises the following detection means and method of (i) a system comprising one or more current transformers located in series with respect to at least one individual solar panel wherein the at least one transformer is located at the input to at least one power inverter, (ii) the system comprises a system component that periodically pulses power to the at least one transformer in a baseline power level pulse, and (iii) the system comprises a detecting means that measures current that flows through the at least one pulsed transformer to measure (a) increased current flow beyond the baseline power level pulse that flows through the at least one pulsed transformer, which results from the capacitance of the at least one solar panel when it is present or (b) fails to measure increased current flow beyond the baseline power level pulse when the at least one solar panel is absent from the system.

In a preferred embodiment, either the current level from the operating at least one solar panel or the current level from the at least one pulsed transformer is detected by at least one associated inverter of the system by using conventional current level detection circuitry which is added to the system described according to the invention. In a further preferred embodiment of the invention, the invention provides a system and method that comprises a micro inverter utilizing the above described detection methods wherein the system registers with the system the presence or absence of the at least one solar panel, and may communicate with the system or an associated system the detection of the presence or absence of at least one solar panel by either a local or remote communication means, or by both local and remote communication means.

In a further preferred embodiment of a solar power generation system that includes a conventional monitoring and notification system with the capability to monitor power output of each inverter during daylight times when the system is producing power, and to communicate the level of power being produced to a local or remote monitor of the power system, the present invention further provides a modified system that adds a means to transmit to the local or remote monitor when at least one solar panel of the power system is missing or is damaged. In a still further preferred embodiment, the monitor and the inverter subsystem are programmed or designed to frequently report the presence of the inverters or monitors as well as the presence or absence of at least one solar panel of the power system.

In another preferred embodiment of the invention, the monitor portion of the monitoring and notification system of the invention is programmed or designed to (i) detect and track the presence or absence of one or more individual panels and their individually associated inverters, (ii) to detect and track the presence or absence of one or more groups of panels and their associated inverters, or (iii) detect and track the presence or absence of (i) and (ii), whether or not the system is producing power or the monitoring process is taking place during the day or night.

In a more preferred embodiment of the invention, the invention provides an alarm that is associated with the monitoring and detecting subsystem, wherein the alarm means: (a) can be a local alarm, (b) can be a remote alarm, or (c) can be both (a) and (b). In a most preferred embodiment of the invention, the alarm can be one or more of the following means: (i) an audible alarm at the monitor, (ii) a connection to a home intruder or home fire alarm system, (iii) an outside light, sound or combination of light and sound alarm located near to, or within hearing or sight of, the one or more solar panels being detected by the monitoring and detecting subsystem, (iv) a means to make an automated phone call to one or more authorities or to one or more authorized person(s) upon the occurrence of a particular monitoring event, (v) an internet alarm to one or more authorities or to one or more authorized person(s), and the like.

In one preferred embodiment of the invention, the monitoring and detecting comprises systems and methods to avoid or minimize false alarms from the alarm means, while including a means to log all notifications and alarms to provide for more efficient servicing of parts or components of the systems, wherein system notifications to the monitor that don't require an immediate alarm means being engaged can be a result of poor connections or result from unreliable components of the power systems the monitor can be designed or programmed to ignore a pre-determined number of notifications of missing or malfunctioning panel(s) or inverter connections prior to engaging one or more alarm means as described above.

In a further embodiment, the invention systems and methods comprise including and using a current transformer in series with panel wiring to detect one or more of series and parallel arcs within the power system wherein the current transformer is located in the system at or near the input of the inverter. In a preferred embodiment of the arc detection system according to the invention, the transformer for detecting the series or parallel arcs has the dual function of being part of the system and method for detecting that one or more solar panel is missing or defective in the power generation system. Further preferred is a transformer comprising a means for preventing DC current saturation within the transformer by a means such as an air-gap in the core of the transformer or similar functioning means to prevent DC current saturation within the transformer.

In a yet further embodiment of the invention, the detection and notification system according to the invention comprises a means for recognizing or measuring sudden changes of panel generated power current through one or more transformers of the power system. In a preferred embodiment the detection means for recognizing or measuring current patterns is a microcontroller. In a further preferred embodiment, the microcontroller comprise an input analog to digital converter to monitor and measure the current within the transformer and may further comprise a digital processing means to recognize the pattern or signature of the arcing when present in the system.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a simplified general schematic that illustrates a solar panel theft and arc protection system and method embodiment of the invention wherein 10 is at least one solar panel in connection with at least one current transformer 20 which is in turn connected to at least one power inverter 30, wherein the at least one power inverter 30 includes a circuit control and detection unit 35, and said at least one power inverter 30 is connected by a communication path to a monitor 40 that is connected via one or more of an Ethernet connector, phone connector or set of relay contacts to a notification target 50. While shown separately, current transformer 20 and power inverter 30 may collectively form a single component.

FIG. 2 is a sample circuit interconnecting portions of a solar panel 100 (corresponds to item 10 in FIG. 1) to a transformer 200 (corresponds to item 20 in FIG. 1) that is then connected to a power inverter 300 (corresponds to item 30 in FIG. 1) and the power inverter 300 includes a circuit control and detection unit 350 (corresponds to item 35 in FIG. 1) as a preferred embodiment of the panel theft and arc protection system utilizing the methods according to the invention. More details for FIG. 2 are described below in the Detailed Description of the Invention.

### DETAILED DESCRIPTION OF THE INVENTION

In one embodiment, the present invention provides a system and method for individual or plural detection of the presence or absence of at least one installed solar panels whether or not the individual solar panel or the plurality of solar panel(s) operates to produce power during the detection process and whether or not the detection is conducted during the day or night, wherein the presence or absence of an individual solar panel or of a plurality of solar panels producing power during detecting comprises detecting presence or absence of one or more solar panels by an associated system that measures power output, and wherein during the detecting process insufficient voltage is produced for the associated system to measure power output, the detection of presence or absence of one or more solar panels comprises the following detection means and method of (i) a system comprising one or more current transformers located in series with respect to at least one individual solar panel wherein the at least one transformer is located at the input to at least one power inverter, (ii) the system comprises a system component that periodically pulses power to the at least one transformer in a baseline power level pulse, and (iii) the system comprises a detecting means that measures current that flows through the at least one pulsed transformer to measure (a) increased current flow beyond the baseline power level pulse that flows through the at least one pulsed transformer, which results from the capacitance of the at least one solar panel when it is present or (b) fails to measure increased current flow beyond the baseline power level pulse when the at least one solar panel is absent from the system.

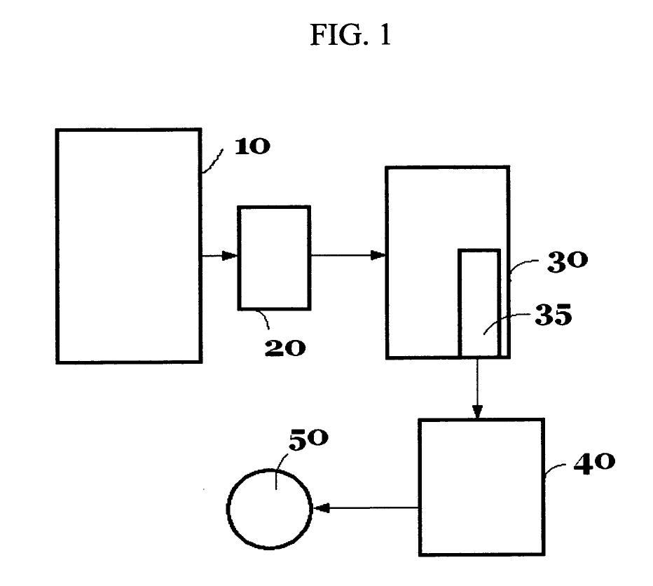

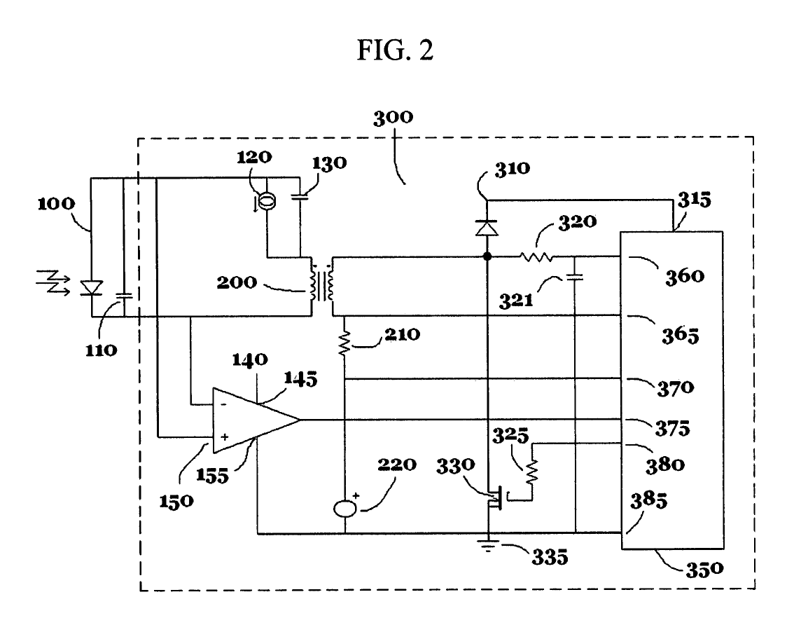

FIG. 1 illustrates a simplified overview for the logical structural flow in the above embodiment of the invention as well as setting forth features that are described herein with regard to other preferred embodiments of the system and methods according to the invention. FIG. 2 illustrates some main components for an embodiment of the invention with an electrical circuit representation for portions of FIG. 1 that includes more technical details. Some structural and logical relationships between FIG. 2 and some portions of FIG. 1. are described in the above Brief Description of FIG. 2. Other structural and logical relationships of these two figures will be apparent to one of ordinary skill in this technical area.

FIG. 2 illustrates a solar panel 100 having an equivalent capacitance 110. The remaining portions of FIG. 2 along with associated electrical connections and logical pathways may be referred to collectively as the inverter 300 that includes two main portions individually or together as a unit, namely a current transformer 200 and control unit 300 along with their associated components and circuits. Significant components are the amplifier 150 with its collector supply voltage (VCC) unit 140, wherein the collector side voltage 145 is a negative voltage (Vcc) and the emitter side voltage 155 is a positive voltage (Vee) and the control unit 350.

In FIG. 2, the housekeeping supply voltage 140 and amplifier 150 connect with plus and minus power connections coming off the solar panel 100 and when taken together with the periodic pulse switch 330 (anti-parallel diode) connected to independent power source 220 provides data to four control input leads at control voltage reference (VREF) 370 input, control voltage of panel input 375, control pulse drive voltage output 380 and zero volts input 385 to detect the presence or absence of the solar panel 100 whether or not the solar panel 100 is generating power at the time of detection. When the solar panel 100 is generating power two other control input leads, control voltage sensor 360 and control amperage/power sensor 365, may also be utilized to detect the presence of the solar panel 100 in the system.

As shown in FIG. 2, power inverter current 120 is current drawn from the solar panel 100 by the power inverter 300. This power inverter current 120 varies at twice the grid frequency (i.e., at zero voltage zero power is drawn by the power inverter 200 and at peak grid voltage the peak current is drawn). The input capacitance 130 is the equivalent capacitance that filters pulsing current to allow the solar panel 100 to supply nearly direct current (DC) to the power inverter 200. The amplifier 150 senses the solar panel voltage. If isolation is needed between the control unit 350 and the solar panel 100, the amplifier 150 would have isolation. This amplifier senses the solar panel 100 voltage and sends it to the inverter control unit 350.

When the solar panel 100 and sunlight are both present sufficient to result in producing a panel voltage, the panel voltage can be utilized by leads on the control unit 350 to detect the presence of the solar panel 100. If insufficient light is present to provide a panel voltage output, or the system otherwise fails to detect a panel voltage output, the system will periodically pulse a periodic pulse switch 330 (FET with anti-parallel diode) connected to independent power source 220. This period pulsing by the system will draw current through portions of the circuit that include positive reference voltage 220, resister shunt 210, a control side coil of the current transformer 220 and the periodic pulse switch 330. If the solar panel 100 is present in the system but just not generating sufficient power to be detected, when the pulse switch 330 is pulsed the impedance of the capacitor located at the solar panel 100 equivalent capacitance 110 this will cause the resister shunt 210 to carry more current (more power) and this extra current will be detected by the control unit 350. When no extra current is present during the periodic pulsing, the control unit unable to detect the solar panel and the solar panel communicates to the monitor 40 (as shown in FIG. 1) that the solar panel 100 is not detected.

In FIG. 2, catch diode 310 is a means for clamping the transformer inductive voltage and allowing the transformer flux to reset.

FIGS. 1 and 2 numbering can be used as a reference to describe a theft detection method according to the invention, if an attempt by a thief is made to short the solar panel 100 wiring to try and fool the incorporated detection and alarm system this will be detected as follows. A short across the panel side of the current transformer 200 will allow large current to flow through the resister shunt 210 portion of the circuit. This excessively high current can be detected by the control unit 350 as a panel fault that is communicated to monitor 40 (see FIG. 1) and an alarm can be given according to system design or system programming. sounded. The monitor 40 depends upon communications from the control unit 350 of the inverter 300 to detect the presence of a functioning control unit 350 and inverter 300 from timed transmissions between the control unit 350 and the monitor 40. However, any theft or malfunction of the power transformer 200 or inverter unit 300 can be detected by the monitor 50 when the monitor 50 detects a failure of the control unit 350 to communicate with the monitor 40 regularly as a result of timed controlled pulses or of timed reports of panel voltage outputs.

According to the invention, a communication path is present between the control unit 350 and the monitor 40 of the system. The monitor 40 portion of the monitoring and notification system of the invention is programmed or designed to (i) detect and track the presence or absence of one or more individual panels and their individually associated inverters, (ii) to detect and track the presence or absence of one or more groups of panels and their associated inverters, or (iii) detect and track the presence or absence of (i) and (ii), whether or not the system is producing power or the monitoring process is taking place during the day or night. The monitor 40 is designed or programmed to issue an alarm to a notification target 50 that may be a person, to a computer system, to authorities or to an alarm system that may sound a local audible or inaudible alarm upon certain communications from the monitor 40. system.

The monitor 40 can be associated with one or more notification target(s) 50 that can have an internal audible or inaudible alarm, and communications between the control unit 350 and the monitor 40, or communications between the monitor 40 and one or more associated notification target(s) 50 can be communicated to by wire or wireless communications, including radio or telephone transmission communications or by flashing lights or recorded loud alarms, etc. One or more of the monitor or notification target may also have a pair of normally closed and or open relay contacts that can trigger a house alarm when the contacts open. Alternately closing of these contacts can trigger an audible alarm near the panels to deter the theft. In addition it may have a telephone jack to make automated calls to preauthorized persons. In this case a prerecorded message would be sent. Another option is to issue an internet message to a preauthorized person. Note the authorized person can include security firms or the police.

Alarms as described above may include any of the following:
Audible alarms located at the monitor, at the notification target or both.
Target input into a home intruder alarm system, or fire alarm system.
Outside audible or flashing light alarm to deter a theft attempt in progress.
Automated phone alarm to a predetermined authorized person.
Automated internet message to a predetermined authorized person or computer system.
Any combination of the above or other similar alarm means.

As noted above, it is possible for connections at a solar panel 100 or other parts of the circuits according to the invention to become loose, which could result in unwanted or excessive alarms. One or more of the control unit 350, the monitor 40 or the notification target(s) 50 can be designed or programmed to require a pre-determined combination of failures or particular event detection before an alarm is recommended or given. In a preferred embodiment, all failures or faults are logged or otherwise recorded by one or more of the control unit 350, the monitor 40 or the notification target(s) 50 as possible notifications of service needed even if an alarm is not recommended or given.

In addition to theft detection and deterrence, in part the invention provides systems and methods that further relate to power systems arc detection, logging, reporting and sounding of alarms as designed or programmed. Arc detection can operate as follows:
The sudden change of panel current is monitored by one or more of the current transformer 200 or inverter 300. Major transient current changes from sudden changes would be clamped by the catch diode 310 portion of the inverter 300 circuits and the anti-parallel diode in the periodic pulse switch 330 (FET with anti-parallel diode) portion of the inverter 300 circuits. A filter with at least one filter resister 320 and at least one filter capacitor 321 filters noise from the current signal to the control unit 350. Positive voltage reference 220 allows the signal to stay positive even when the transformer swings negative.
The transformer 200 and its circuits portion of the inverter 300 system are designed so that the transformer 200 will not saturate even with the maximum arc current. This is usually achieved by gapping the magnetic core of the transformer 200.
The control monitors the comparison of the control voltage sensor 360 (VSENSE control lead input) to reference voltage 365 signal. Either a sudden increase of current or a sudden decrease of current indicates the onset of arcing. The control detects the signature of this current according to an expected signature. When the signature matches that of arcing for this system the control signals the presence of arcing to the system. The inverter 300 turns itself off to quench the arc and can then have the control unit 350 signal this system state to the monitor 40.
Once one or more of the monitor 40, notification target 50, or inverter control unit 350 logs the arc fault the inverter can then be designed or programmed to follow a preset restart sequence. This can consists of a short delay to allow heated parts to cool. The inverter can then be allowed to restart. If the arcing is again detected the inverter an again turn off and signal arc fault as described above. Again, one or more of the monitor 40, notification target 50, or inverter control unit 350 can then wait for cooling and try to restart the inverter. This cycle will be repeated for the number of restart tries the system is designed or preprogrammed for arcing restarts.
After a preset number of attempted arcing restarts, in a preferred embodiment the inverter is left turned off and one or more of the monitor 40, notification target 50, or inverter control unit 350 signals a service call to a notification target, for example, or may signal a need for service via a front panel display on the system, by an internet message through an Ethernet connector or some other equivalent or similar notification means.

In a preferred embodiment, either the current level from the at least one operating solar panel or the current level from the at least one pulsed transformer is detected by at least one associated inverter of the system by using conventional current level detection circuitry which is added to the system described according to the invention. In a further preferred embodiment of the invention, the invention provides a system and method that comprises a micro inverter utilizing the above described detection methods wherein the system registers with the system the presence or absence of the at least one solar panel, and may communicate with the system or an associated system the detection of the presence or absence of at least one solar panel by either a local or remote communication means, or by both local and remote communication means.

In a further preferred embodiment of a solar power generation system that includes a conventional monitoring and notification system with the capability to monitor power output of each inverter during daylight times when the system is producing power, and to communicate the level of power being produced to a local or remote monitor of the power system, the present invention further provides a modified system that adds a means to transmit to the local or remote monitor when at least one solar panel of the power system is missing or is damaged. In a still further preferred embodiment, the monitor and the inverter subsystem are programmed or designed to frequently report the presence of the inverters or monitors as well as the presence or absence of at least one solar panel of the power system.

In a more preferred embodiment of the invention, the invention provides an alarm that is associated with the monitoring and detecting subsystem, wherein the alarm means: (a) can be a local alarm, (b) can be a remote alarm, or (c) can be both (a) and (b). In a most preferred embodiment of the invention, the alarm can be one or more of the following means: (i) an audible alarm at the monitor, (ii) a connection to a home intruder or home fire alarm system, (iii) an outside light, sound or combination of light and sound alarm located near to, or within hearing or sight of, the one or more solar panels being detected by the monitoring and detecting subsystem, (iv) a means to make an automated phone call to one or more authorities or to one or more authorized person(s) upon the occurrence of a particular monitoring event, (v) an internet alarm to one or more authorities or to one or more authorized person(s), and the like.

In one preferred embodiment of the invention, the monitoring and detecting comprises systems and methods to avoid or minimize false alarms from the alarm means, while including a means to log all notifications and alarms to provide for more efficient servicing of parts or components of the systems, wherein system notifications to the monitor that don't require an immediate alarm means being engaged can be a result of poor connections or result from unreliable components of the power systems the monitor can be designed or programmed to ignore a pre-determined number of notifications of missing or malfunctioning panel(s) or inverter connections prior to engaging one or more alarm means as described above.

In a further embodiment, the invention systems and methods comprise including and using a current transformer in series with panel wiring to detect one or more of series and parallel arcs within the power system wherein the current transformer is located in the system at or near the input of the inverter. In a preferred embodiment of the arc detection system according to the invention, the transformer for detecting the series or parallel arcs has the dual function of being part of the system and method for detecting that one or more solar panel is missing or defective in the power generation system. Further preferred is a transformer comprising a means for preventing DC current saturation within the transformer by a means such as an air-gap in the core of the transformer or similar functioning means to prevent DC current saturation within the transformer.

In a yet further embodiment of the invention, the detection and notification system according to the invention comprises a means for recognizing or measuring sudden changes of panel generated power current through one or more transformers of the power system. In a preferred embodiment the detection means for recognizing or measuring current patterns is a microcontroller. In a further preferred embodiment, the microcontroller comprise an input analog to digital converter to monitor and measure the current within the transformer and may further comprise a digital processing means to recognize the pattern or signature of the arcing when present in the system.

As shown in FIG. 2, when switch 330, typically a FET with anti-parallel diode, turns on current flows from source 220 through shunt 210 to transformer 200, through switch 330 and returns through ground connection 335. When switch 300 turns of diode 310 provides a path for transformer 200 to reset.

Other aspects and advantages of the present invention will become apparent from the following detailed description, taken in conjunction with the accompanying drawings, illustrated by way of example of the principles of the invention.

The scope of the invention is to be defined by the claims appended hereto and their equivalents.

What is claimed is:

1. A solar power generation system comprising at least one solar panel and at least one power inverter with said at least one power inverter further comprises at least one current transformer unit primary that is located in series with the wiring of said at least with solar panel, wherein said at least one current transformer is part of a system means for detection one or more selected from the group of the presence or absence of the at least one solar panel and the presence or absence of electrical arcing within the system.

2. The solar power generation system of claim 1 wherein said current transformer unit comprises a means to withstand full load current without saturating, or said current transformer unit is designed with a means to withstand full load current without saturating.

3. The solar power generation system of claim 1, wherein said current transformer unit is connected to a voltage reference source and the system comprises a means for detecting a single polarity voltage.

4. The solar power generation system of claim 2, wherein the current transformer unit can be reset using a catch diode that may be located within the inverter unit circuits, wherein the catch diode in combination with at least one FET with its anti-parallel diode can periodically pulse can form a voltage clamp to limit voltages applied to a control unit circuit.

5. The solar power generation system of claim 2, wherein said inverter comprises a filter unit, wherein the filter unit includes a circuit comprising at least one resister and at least one capacitor as a means to limit excess high frequency noise within the inverter circuit.

6. The solar power generation system according to claim 1 wherein said inverter further comprises a means for sensing panel voltage for detecting the presence or absence of the panel in said solar power generation system, a means for pulsing the current transformer secondary for detecting the presence or absence of the solar panel in said solar power generation system, and a means for monitoring the current transformer secondary current.

7. The solar power generation system according to claim 1 wherein said solar panel sensing means comprises one or more of (i) a means for detecting panel voltage when the panel is illuminated by light sufficiently for detection of a panel output voltage, and (ii) a means for detecting panel equivalent capacitance as a means for detecting the presence or absence of said solar panel when said solar panel is not sufficiently illuminated by light for a panel output voltage to be detected by an output voltage detecting means.

8. The solar power generation system according to claim 7 wherein the inverter further comprises a control unit designed or programmed to provide a communication of a solar panel missing signal to a monitoring unit from detecting one or more of the absence of solar panel output voltage or absence of a correct pulsed panel current detecting means detection of pulsed panel current equivalent capacitance that would indicate the presence of said solar panel in the system.

9. The solar power generation system according to claim 8 wherein the monitoring unit comprises a means for recording one or more of a panel missing signal or an inverter missing signal, and the monitoring unit may optionally further comprise a means for communicating with a notification target that may be one or more of a machine, a person, an alarm or the like.

10. A solar power generation system according to claim 9, wherein one or more of the inverter control unit, the monitoring unit, or the notification target is designed or pre-programmed to issue an alarm when a predetermined number of inverters absent or a predetermined number of solar panels absent or signals are detected or are received, wherein said alarm may be communicating with an audible device, opening or closing relay contacts to a notification target alarm system, sending a message to a phone connector or engaging a unit that sends the phone message, sending a message to the internet via an Ethernet connector, wireless connector, or the equivalent, or engage another acceptable alarm.

11. The solar power generation system according to claim 2 further comprising an arc detect breaker and a grid breaker to protect the grid to inverter circuit from arc damage.

12. The solar power generation system according to claim 11 wherein the inverter unit further comprises an arc detecting means that detects one or more of sudden increases in current or sudden decreases in current to detect system arcing.

13. The solar power generation system according to claim 12 wherein one or more typical current signatures of arcing is used as a reference to detected data to confirm that arcing is occurring, and when arcing is detected the inverter power stage is turned off and a signal is sent to the monitoring unit to communicate an arc failure status.

14. The solar power generation system according to claim 13 wherein the control unit of the inverter unit comprises circuitry or firmware to compare actual current data with one or more stored current signatures to further confirm the detection of arcing.

15. The solar power generation system according to claim 12 wherein the arc detecting means turns off the inverter power stage and a communication is sent to at least one monitor to communicate an arc failure status, and one or more of the monitor and inverter is designed or programmed to wait for the arc to fully quench and the to restart the inverter, and upon restart if arcing is again detected within a set time period the inverter is set down again with the detection and shut down processes being repeated for a number of times that the system is designed or programmed to retry, and the inverter is shut off and a communication of service needed is issued if arching continues for the set number of cycles of arc detection and inverter restarts.

16. The solar power generation system according to claim 15 wherein the service needed communication is selected from one or more of a phone message to a service provider, an internet message to a service provider, a service message to a monitor, or a service needed system light is turned on.

17. A method for detecting one or more of (i) the presence or absence at least one solar panel in a solar power generation system location, (ii) the presence or absence at least one power inverter unit in a solar power generation system location, or (iii) the presence or absence of arcing in a solar power generation system location, wherein said method of detecting utilizes the solar power generation system according to claim 1.

18. A method for detecting the presence or absence of at least one solar panel in a solar power generation system location, wherein said method for detecting utilizes the solar power generation system according to claim 1.

19. A method for detecting the presence or absence of at least one power inverter unit in a solar power generation system location, wherein said method of detecting utilizes the solar power generation system according to claim.

20. A method for detecting the presence or absence of arcing in a solar power generation system location, wherein said method of detecting utilizes the solar power generation system according to claim 1.
